(19) United States
(12) Patent Application Publication
(10) Pub. No.: US 2013/0328683 A1
(43) Pub. Date: Dec. 12, 2013

(54) SURVIVAL NECKLACE

(71) Applicants: David Eduard Sitbon, Beer Sheva (IL); Harel Gilutz, Beer Sheva (IL)

(72) Inventors: David Eduard Sitbon, Beer Sheva (IL); Harel Gilutz, Beer Sheva (IL)

(73) Assignee: U-SEE 2 PROMOTION LIMITED, Limassol (CY)

(21) Appl. No.: 14/001,198

(22) PCT Filed: Feb. 27, 2012
(86) PCT No.: PCT/IL2012/000092

§ 371 Date: Aug. 23, 2013

(30) Foreign Application Priority Data
Feb. 28, 2011 (IL) 211481

(51) Int. Cl. G08B 21/08

(52) U.S. Cl. CPC G08B 21/088
USPC 340/573.6

(57) ABSTRACT

A life saving necklace for a drowning person that comprises microphones for receiving voices originated from the throat of a drowning person; a processor for processing signals received from the microphones represent coughs that are typical to a drowning person and for automatically transmitting a distress signal to a base station; a memory for storing data and operating software for the processor; an electric power source for providing power to the electrical components of the necklace.

### FIELD OF THE INVENTION

The present invention relates to the field of drowning alert systems. More particularly, the present invention relates to a system for alerting of a drowning person in a determined area, which is based on acoustical sensing of the respiratory system and appropriate signal analysis.

### BACKGROUND OF THE INVENTION

Drowning is a major global injury problem and is the second leading cause of unintentional injury death after road traffic accident. As a result, many solutions have been developed to the problem of preventing drowning.

Pathophysiology

Drowning is a process resulting in primary respiratory impairment from submersion in a liquid medium. The outcome may cause morbidity or mortality. After initial gasping and possible aspiration, immersion stimulates hyperventilation, followed by a voluntary apnea and a variable degree and duration of laryngospasm.

Asphyxia leads to the relaxation of the airway, which in many individuals, allows the lungs to take in water, usually less than 4 mL/kg of fluid (previously referred to as “wet drowning”), Approximately 10-20% of individuals maintain tight laryngospasm until cardiac arrest occurs and inspiratory efforts have ceased. These victims do not aspirate any appreciable fluid (previously referred to as “dry drowning”). Most individuals are found after having been submerged in liquid for an unobserved period of time.

The target organ of drowning injury are the lungs. Aspiration of 1-3 mL/kg fluid leads to significantly impaired gas exchange and hypoxia and ischemic acidosis leading to secondary other organ injury.

The insult to the Central Nervous System (CNS) in the primary determinant of subsequent outcome as it is highly vulnerable to hypoxia. The CNS can tolerate hypoxia for no more than 4-6 minutes before potentially irreversible damage may occur.

Drowning Symptoms

Drowning is a silent killer. People who are drowning may not be able to call for help because they are expending all their energy to breath or to keep their head above water. Furthermore, as water is introduced into the respiratory tract, the airway may go into a spasm, making it difficult to call for help. Children who are unable to swim may submerge in less than one minute. Adults may struggle longer.

Drowning Sequence

A typical drowning sequence is illustrated in FIG. 1. Drowning occurs when water comes into contact with the larynx (voice box) and may be either symptomatic or asymptomatic.

Symptomatic, drowning is characterized by the following symptoms:
Anxious behavior; the drowning person panics and struggles as well as presenting tachypnea and dyspnea.
If water has entered the airways then extreme cough and/or wheeze and/or gasp may appear.
After an initial gasp followed by submersion, there is an initial voluntary breath holding.

There after, both symptomatic and asymptomatic patients may present with any of the following:
Apnea
Hypoxemia causing alternation of vital signs (e.g., tachycardia, bradycardia), followed by spasm of the larynx.
Loss of consciousness that may begin within three minutes after submersion.
Cardiopulmonary arrest: asystole, ventricular lethal arrhythmias and bradycardia (55%, 29%, 16% accordingly)

As body functioning declines, the larynx may relax, thereby causing water aspiration. However, up to 20 percent of the drowning victims have persistent spasm of the larynx, and no water is aspirated.

U.S. Pat. No. 7,554,453 disclose a worn water alarm device which gives an alarm when a person is drowning. However, the device proposed by U.S. Pat. No. 7,554,453 suffers from several significant drawbacks:
(a) it may cause inconvenience since it may entangled with floating object on the water (plastic bags and alike).
(b) in case that the alerting unit is detached from the collar for any reason a false alarm will be activated.
(c) the drowning alert system will be activated (and cause a false alarm) when a person decides to dive, therefore it limits the bather's enjoyment.

U.S. Pat. No. 6,935,335 and WO 09/153681 disclose systems for treating and monitoring a patient whose physical condition may require medical assistance that may be given by the medical stuff or some automatic stimulation. In both references microphones are attached near the airway of a person and they use signal processing methods for analyzing the output signal which is followed by an automatic decision and action. In both references a microphone is attached to a necklace that is wrapped around the patient's neck. However, these systems can not be used for drowning detection even though drowning is detected by a similar method because of several reasons:
(a) Drowning detection requires the said necklace to be waterproof.
(b) In drowning scenario different pattern are sought.
(c) Unlike a monitored patient, the location of the drowning person is unknown.

Therefore, it is a primary object of the present invention is to provide a drowning alert systems which overcomes all the drawbacks of the prior art.

It is an object of the present invention to provide a drowning alert system, which activates an alarm of a drowning event and informs the lifeguard with the location of a drowning person.

Another object of the present invention is to provide a drowning alert system which is capable of learning the personal acoustic attributes of the user.

A further object of the present invention is to provide a drowning alert system that is gauged according to personal acoustic characteristics.

It is also an object of the present invention to provide a drowning alert system that provides a visual and/or audible location alert when a drowning person is detected.

An additional object of the present invention is to provide a reliable drowning alert system that will minimize the number of false alarms.

Other objects and advantages of the invention will become apparent as the description proceeds.

### SUMMARY OF THE INVENTION

The present invention is directed to a life saving necklace for a drowning person, that comprises:
one or more microphones for receiving voices originated from the throat of a drowning person;
a processor for processing signals received from the microphones represent coughs being typical to a drowning person and for automatically transmitting a distress signal to a base station;
a memory for storing data and operating software for the processor; and
an electric power source for providing power to the electrical components of the necklace.

The processor may process signals received from the microphones according to the following steps:
a) assigning a filter to each channel, according to the relevant frequency band of the cough signal;
b) isolating the cough signals from environment noises using Blind Source Separation (BSS), according to the location of each source on the neck;
c) performing segmentation of the cough signals into constant or variable segments, according to the types of signals;
d) extracting the cough attributes from each segment, using a Short-Term Fourier Transform (STFT) or a Fast Wavelet Transform (FWT);
e) classifying the attributes by comparing the patterns of each segment or several segments to cough patterns of a bather and of other bathers that are stored in a database; and
f) making a decision whether or not the cough is related to a distress condition, according to the comparison results.

The present invention is also directed to a drowning detection and alert system, that comprises:
a) a life saving necklace for a drowning person, including:
one or more microphones for receiving voices originated from the throat of a drowning person;
a processor for processing signals received from the microphones represent coughs being typical to a drowning person and for automatically transmitting a distress signal if necessary;
a transceiver for communicating with a base station, that includes:
   a receiver being capable of receiving the distress signal
computational means and display means operable to provide, when a drowning event is detected, an audio visual alarm including the location of a drowning person;
a memory for storing data and operating software for the processor; and
an electric power source for providing power to the electrical components of the necklace.

The present invention is further directed to a drowning detection method, comprising the steps of:
(a) obtaining pre-stored patterns of user characteristic cough and breathing;
(b) averaging input signals from one or more microphones and produce an averaged signal;
(c) filtering out irrelevant frequencies from the average signal;
(d) identifying whether the signal represents cough by recognizing explosive sounds;
(e) identifying whether the breathing and cough sounds are not in the predefined personal expected pattern;
(f) generating a distress signal to be received by a base station; and
(g) activating an audio visible alarm.

An alarm may be generated if the following conditions occur:

Identification of an “alarm cough” which is one of the following patterns:
a. cough pattern with characteristics different from the calibrated user characteristics;
b. cough pattern with a predefined increasing intensity;
c. at least four intense coughs within 15 seconds;

Identification of non physiological signals:
a. wheezing
b. bather specific and predefined apnea duration (range: 7-20 seconds) is detected 5 Sec after an identification of an “alarm cough”;
c. apnea longer than 7 seconds is detected;
d. a loss of background noise which was present in the last 7-20 seconds;
e. continuous change of frequencies (which frequencies?) for a time period of more than 15 seconds; I don't understand
f. a combination of apnea immediately after “alarm cough” is detected.

The microphone may be an electret microphone units powered from a 9V battery. An operational amplifier may also be added to the output of the microphone.

Routing between microphones may be done by an FPGA.

Voice signals may be analyzed by calculating Mel-Frequency Cepstral Coefficients and applying a Discrete Cosine Transform (DCT) operation.

MEMS technology may also be used to detect voice.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 (prior art) graphically illustrates the phases of a drowning sequence;

FIG. 2 (prior art) graphically illustrates the phases of a two-phase cough sound signal (period 1: explosive phase; period 2: intermediate phase);

FIGS. 3a-3d (prior art) illustrate four methods of coughing quantification;

FIG. 4 (prior art) illustrates a typical cough analysis containing three areas of interest;

FIG. 5 prior art) is a flow chart of the process of cough reconstruction and classification method;

FIG. 6 illustrates a survival necklace, according to an embodiment of the present invention;

FIG. 7 illustrates a monitored bathing zone, according to an embodiment of the present invention;

FIG. 8 illustrates a possible implementation of the necklace worn by a bather, according to an embodiment of the invention;

FIG. 9 is a block diagram of the signal processing which is performed in the necklace, according to an embodiment of the invention;

FIG. 10 shows a drowning event at a monitored bathing zone, as displayed in the lifeguard's station, according to an embodiment of the invention;

FIG. 11 (prior art) shows a possible set of conditions for generating an alert; and

FIGS. 12-19 show possible implementations of voice reception and Processing.

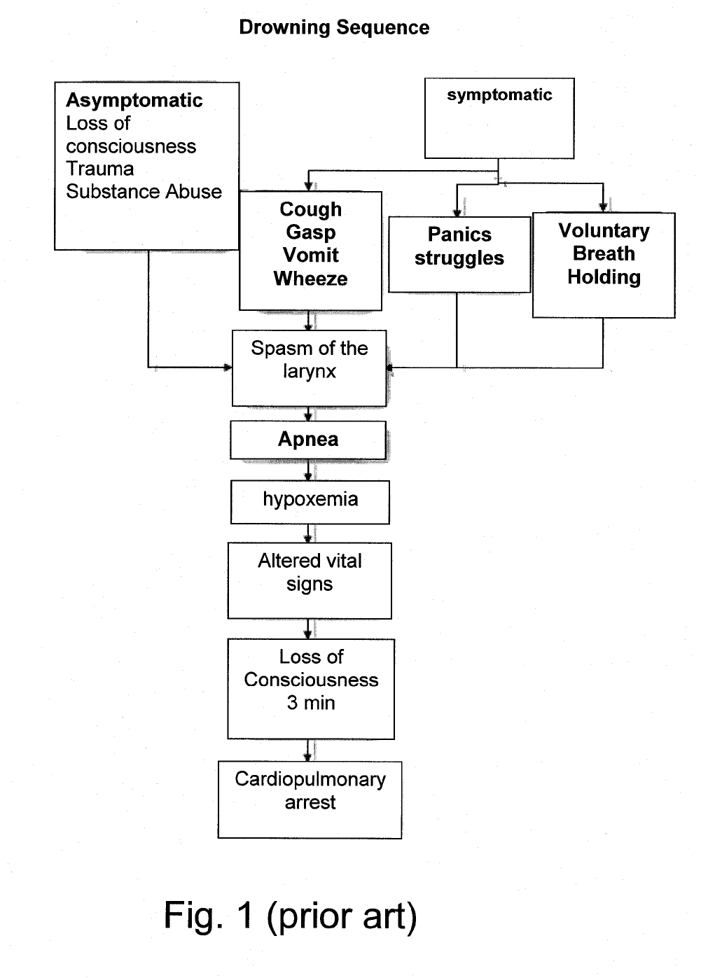

### DETAILED DESCRIPTION OF THE INVENTION

According the present invention, detecting a drowning event consists of two steps:

a) sensing, signal processing and analyzing whether a drowning event is occurs (obviously this detection process is iterative and takes place inside a survival necklace).

b) activating an audio-visual alarm for informing rescue personnel of the exact location of the drowning event (hereinafter the survival necklace will be referred to as ‘necklace’).

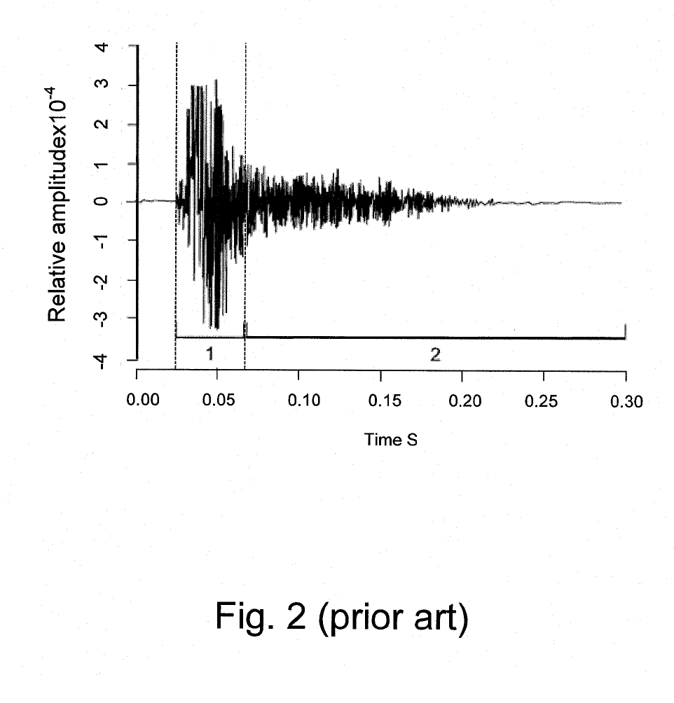

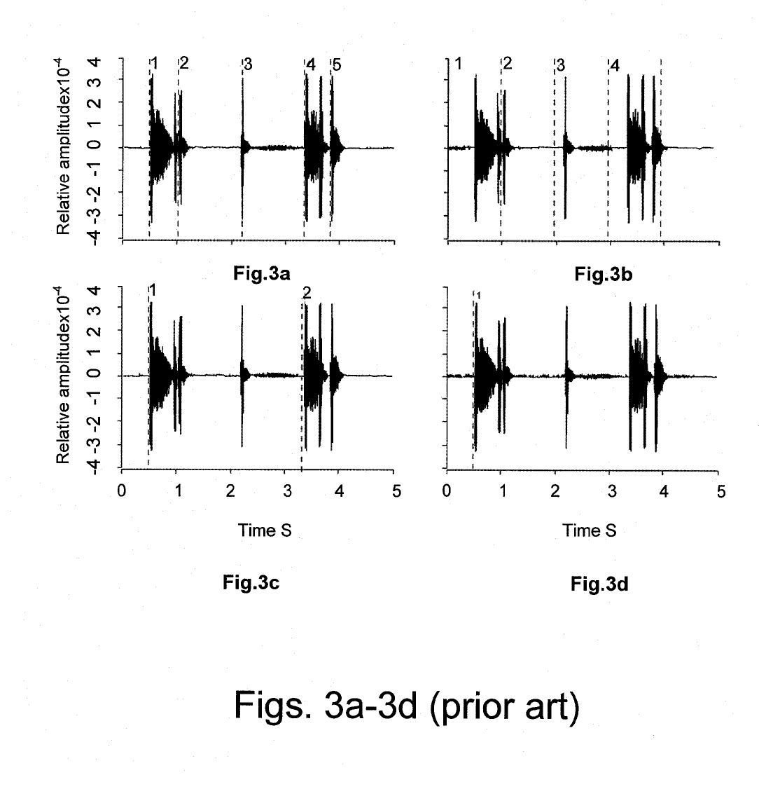

Coughing produces a characteristic sound, which is shown in FIG. 2. The sound results from rapid changes in airflow generated by the contractions of muscles in the chest wall, abdomen, diaphragm and larynx. Hence, a variety of modalities can be used to detect coughing (as shown in FIGS. 3a-3d).

The recognition process occurs every predetermined period and it includes several stages. Typical signals representing a single cough in the time domain are shown in FIG. 2 and are built of several characteristic phases.

One of the phases shown in FIG. 2 is called “an explosive phase” and it is characterized by extremely high amplitude peaks in intensity, which averagely lasts 50 mS and comprises most of the energy. The second phase is called the ‘intermediate phase’ and lasts from 50 mS up to 200 mS.

All the following four methods of coughing quantification, shown in FIGS. 3a to 3d, are based on identification of the above basic phases for four coughing variations that belong to four different people.
The first method (shown in FIG. 3a) is based on counting of explosive cough sounds.
(ii) The second method (shown in of FIG. 3b) is based on the time spent coughing, i.e. the number of seconds per hour containing at least one explosive coughs sounds.
(iii) The third method (shown in of FIG. 3c) is based on counting the number of breaths which contain at least one explosive cough sound.
(iv) The fourth method (shown in of FIG. 3d) is based on counting of the duration of continuous coughing sounds without a two phase pause.

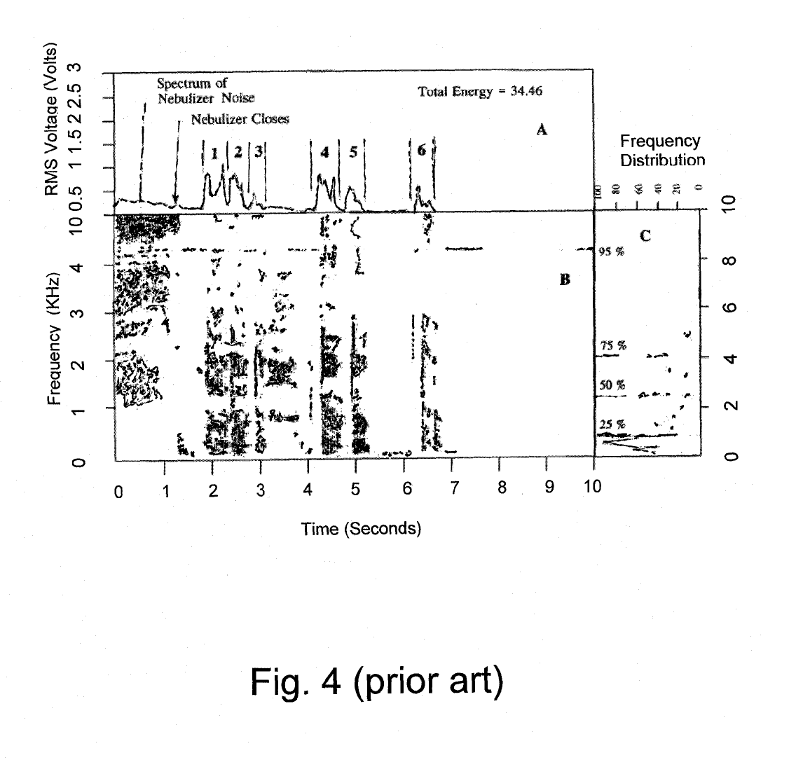

FIG. 4 illustrates a typical cough analysis containing three areas of interest. Area A is a graph of the instantaneous root mean square (RMS) sound pressure level of cough. Considering the graph from time zero, it can be seen that inhalation terminates in a small localized peak due to the sound of the closure of the nebulizer valve at about 1.3 s. There is then a quiet period, during which the subject continues to inhale until the onset of cough (defined as the “time to onset” of the first cough). The RMS trace then shows the individual coughs and where the peak and troughs of energy within an individual cough lie, producing similar but more accurate and detailed information than the standard time domain tussigrams.

Area B is the spectrogram. Time is on the horizontal axis, frequency on the vertical axis and sound pressure level is represented by a grey scale. Moving from left to right, this shows the sound of the nebulizer lasting approximately 1.3 s followed immediately by a short low frequency sound, which represents the closure of the nebulizer valve. There is then a quiet period of about 0.6 Sec, defined as the time to onset. There follows a series of three coughs, a short period of inspiration and further two coughs. There is then a quiet pause and a final cough.

Area C is the spectral energy in that part of the spectrogram in which cough was present. It shows the frequency distribution of the acoustic energy in the coughs alone, with the spectral energy of the nebulizer having been excluded. The horizontal lines are the frequencies below which 25, 50, 75 (quartile frequencies) and 95% (spectral edge frequency) of the total energy of the spectrogram is contained.

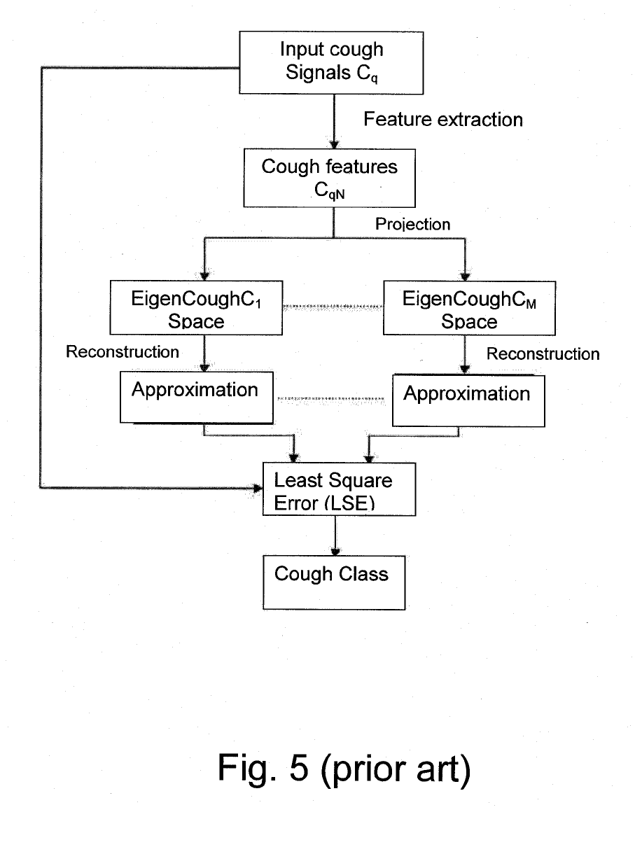

FIG. 5 is a flow chart of the process of cough classification. First the set of features of an unclassified (novel) cough (Cq) were extracted and normalized (CqN). Then values of (CqN) were projected onto each of the cough class subspaces to obtain the following set of weight coefficients as described by Equation 1:

{w_{ω}}=(C_{qN}−μ_{ω})^{T}×[u_{1ω}u_{2ω′},u_{jω′},u_{Kω}],ωε{‘C₁’,‘C₂’ . . . ‘C_{M}’}, (Eq. 1)

In the above expression, μω represents the mean vector, and ujω is the jth eigenvector of class ω. The weight sets were then used along with the sample means to reconstruct CqN in each class subspace, thus obtaining the approximations \hat{T}_{C1}, . . . , \hat{T}_{CM}:

\hat{T}_{ω}=μ_{ω}+[u_{1ω}u_{2ω′},u_{iω′}u_{Kω}]×w^{T}_{ω′}ωε{‘C₁’,‘C₂’ . . . ‘C_{M}’}, (Eq. 2)

Next the representation error between CqN and its approximation in each class was determined as follows:

ε_{ω}=Σ(\hat{T}_{ω}−C_{qN})²,ωε{‘C₁’,‘C₂’ . . . ‘C_{M}’}, (Eq. 3)

Finally, the novel cough coefficient Cq was assigned to class ω based on the least square error rule as follows:.

$${t}_{q} -> ω \vert ω = {argmin}_{〈 al 〉} \{ {ɛ}_{ω} \} , ω ∈ \{ {{}_{}^{‵}{C}{}_{1}^{}}^{′} , {}_{}^{‵}{{C}_{2}}{}_{}^{′} … {}_{}^{‵}{{C}_{M}}{}_{}^{′} \} , \qquad ( Eq . 4 )$$

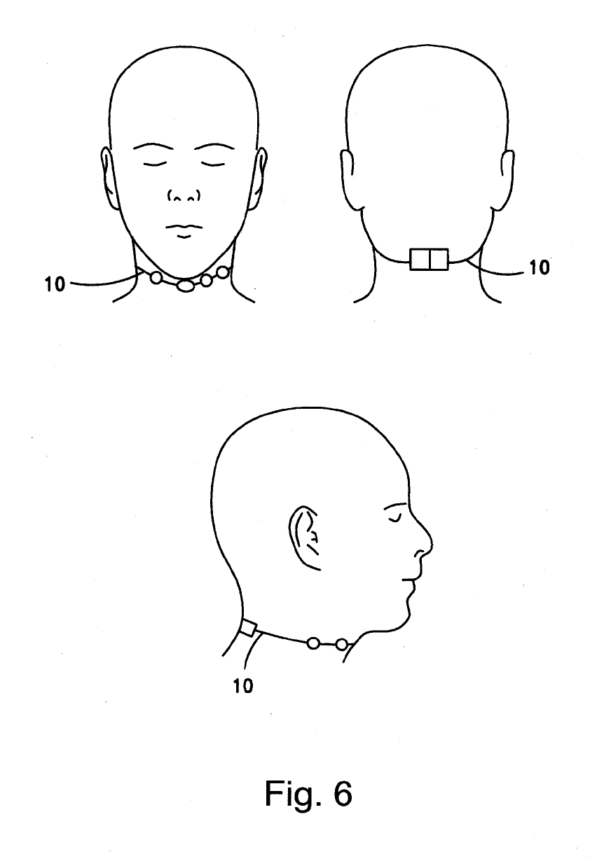

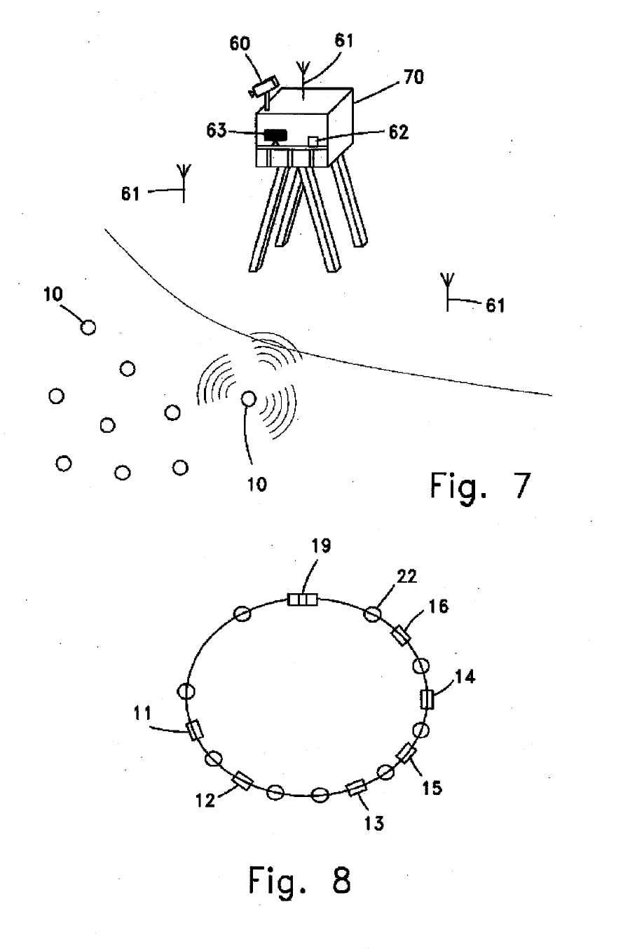

FIG. 6 illustrates in general view the necklace. A plurality of necklaces 10, each of which is worn by an individual person is monitored simultaneously at a determined bathing area. A bathing area can be, for example a swimming pool or a segment of the bathing zone, as illustrated in FIG. 7. The lifeguard's station 70 is equipped with computation means for activating an audio visual alarm whenever one of the monitored necklaces transmits a distress signal.

FIG. 7 illustrates with a plurality of bathers in a bathing zone, wherein each bather is wearing the necklace 10 and represented by a small circle. The lifeguard station 70 is located several meters from the sea shore. The lifeguard station is equipped with 3 antennas 61, a receiver 62 and a screen 95. The lifeguard station receives the distress signal and gives the lifeguard the location of the drowning person.

FIG. 8 illustrates a possible implementation of necklace 10, which is worn around the neck (as illustrated in FIG. 6) and consists of several microphones 22, each of which is located in a separate segment of the necklace 10. The microphones 22 are equally distributed along the circumference of the necklace. The plurality of microphones 22 serves the need of having continuous measurements from the area surrounding the trachea, even if the survival necklace has been rotated for some reason. For this reason, it is preferable to symmetrically distribute 6-8 microphones along the circumference of the necklace. In addition to the microphones 22, the segments of the necklace contain a memory 13, a processor 12, a transmitter 11, a battery 15, a pulse sensor 14, an electrical circuitry 16 and a locking unit 19, which also functions as a switch for activating its components, when locked. As a result of processing the data collected by microphones 22, the necklace 10 continuously makes a decision regarding the condition of the bather and a distress signal is transmitted, if necessary. In order to perform this continuous decision process, the processor performs a step of coughing quantification on the acoustic input signal. The processor studies the personal voluntary cough as a baseline.

Additionally, the data processing is based on having several data sets coming from several independent microphones for reducing errors. The transmitter 11 transmits a signal, which indicates the lifeguard about the joining or leaving of a bather to the monitored area.

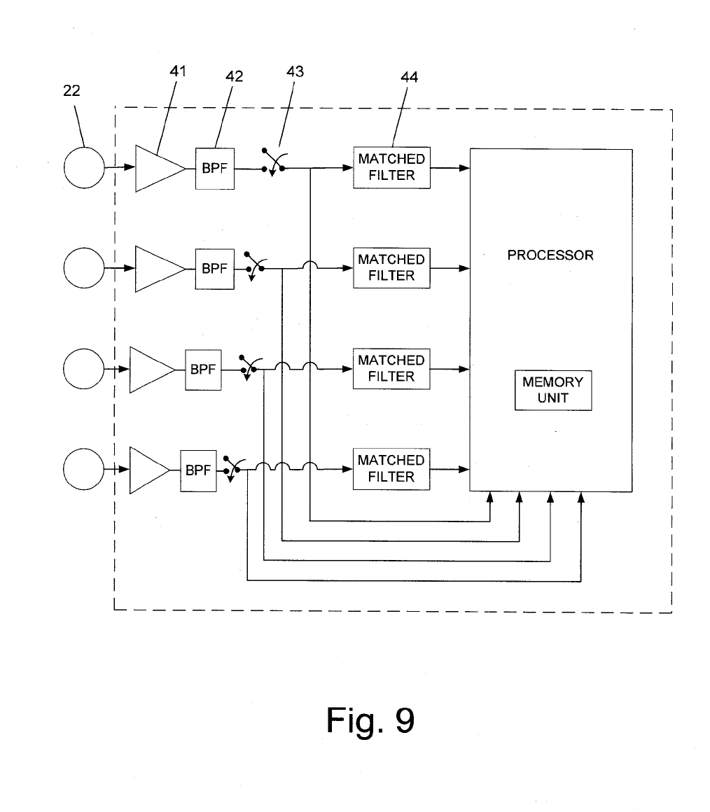

FIG. 9 is a block diagram of the signal processing which is performed in the necklace. The processor 12 performs an iterative process which provides a decision whether to generate an alert signal. For this purpose, the information fed into the processor 12 has to be digital. Each microphone 22 supplies continuous analog signal which is amplified by a pre-amplifier 41 and filtered by an anti-aliasing band-pass-filter 42 having a typical pass-band of 10 Hz to 10 KHz. The filtered signal is than sampled by a sampling module 43 at Nyquist frequency (20 KHz in this case). Therefrom, the sampled data is filtered in a matched filter 44 (implemented by software), such that it contains only information about the relevant frequency components. The relevant data is received at the processor 12 which is equipped with appropriate software means for processing the data. Data processing includes the following steps:
(a) Personal cough calibration—The person that should be monitored will be requested to perform a set of short voluntary coughs. The system will learn the intensity, power and frequencies for creating a “normal” cough pattern using a short training process. This pattern is then stored in memory 13.
(b) Personal breathing sound calibration—The person that should be monitored breathing sounds will be learned, while the person is asked to take and exhale deep breath, in particular the absence of wheezing for creating a “normal” breathing pattern, which is also stored in memory 13. In addition, the microphones may deliver noise signals which are typical to the noise received underwater.
(c) Background noise reduction—The system will learn the background noise to be ignored in predefined limits. The system also will be able to indentify underwater silence, so as to detect apnea.
(d) Calculating the time-frequency distribution for the relevant frequency range. In order to separate coughing-related signals from all other signals, an Independent Component Analysis (ICA—a technique that recovers a set of independent signals from a set of measured signals. It is assumed that each measured signal is a linear combination of each of the independent signals, and that there are an equal number of measured signals and independent signals) process is performed on each data channel that corresponds to a microphone.
(e) Performing frequency transformations such as short-time Fourier Transform or a Fast Wavelet Transform, using a sliding time window of 10-50 mS. The processor calculates the coefficients which comprise most of the energy of the signal, to generates a pattern for each window.
(e) Accessing the memory unit and comparing the amplitude-frequency pattern to a pre-measured amplitude-frequency pattern.
e) Calculating the correlation between both patterns. If the correlation is higher that a predetermined threshold value, then a positive decision about a cough is made, followed by a positive decision about a sequence of coughs which results in activating a drowning alert.

The cough signals are processed according to the following steps:

At the first step, a filter is assigned to each channel, according to the relevant frequency band of the cough signal (e.g., 20 Hz-4 KHz); At the next step, the cough signal is isolated from environment noises using Blind Source Separation (BSS), according to the location of each source on the neck; At the next step, the cough signals pass segmentation to constant or variable segments, according to the types of signals; At the next step, the cough attributes are extracted from each segment, using a Short-Term Fourier Transform (STFT) or a Fast Wavelet Transform (FWT); At the next step, these attributes are classified by comparing the patterns of each segment or several segments to cough patterns of the bather (and of other bathers) that are stored in a database; At the next step, the comparison results are used to make a decision whether or not the cough is related to a distress condition.

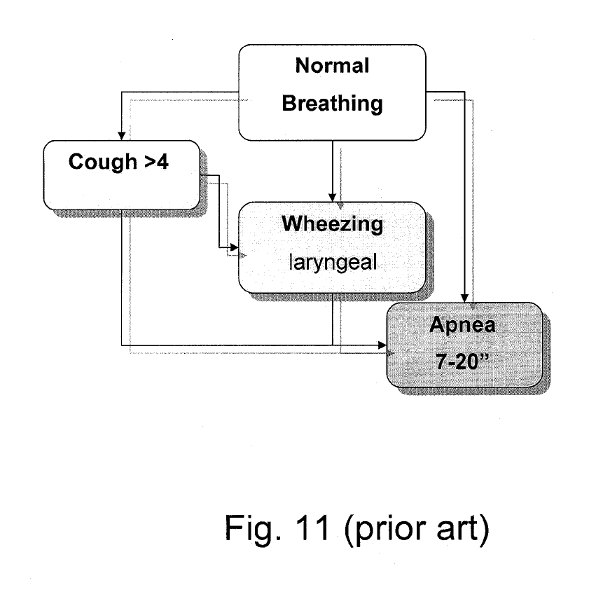

FIG. 11 shows a possible set of conditions for generating an alert, which is activated. For example. upon detecting 4 subsequent coughs, wheezing or apnea. The time may be personally adjusted to be in the range of 7-20 seconds, according to the bather capabilities. The number of subsequent coughs may also be adapted to the physiological attributes of each bather.

A signal is then sent to the transmitter 11. As long as the breathing sounds and cough are in the pre defined personal expected pattern no alarm signal will be generated. Whenever a drowning event is detected, an emergency signal is transmitted from the transmitter 11.

The system may be configured to identify 4 subsequent coughs, which may be an indication regarding actual or impending distress. The system will be able to react within a time interval of 2-7 Sec.

The transmitted signal is received by each one of the 3 antennas 61 and transferred to a stationary processing unit 83 which calculates the exact location of the drowning bather. As the exact location of the drowning person is known, the system calculates the distance, azimuth and elevation angles and provides a visual indication on the display screen 95, such that the lifeguard can instantaneously reach the drowning person. After calculating the azimuth and elevation angles, the video camera 66 is directed to the drowning person such that additional indication about the drowning person is displayed on the screen 95.

Calculating the Location

As indicated before, since the three antennas are located in 3 different spatial points on the monitored sea-shore or swimming pool, the signal transmitted from the relevant survival necklace 10, is received in different timing by each antenna. The exact calculation can be calculated by triangulation methods, such as described for example, in WO 01135329.

According to an embodiment of the invention, the processor contains a GPS device.

The Display Unit

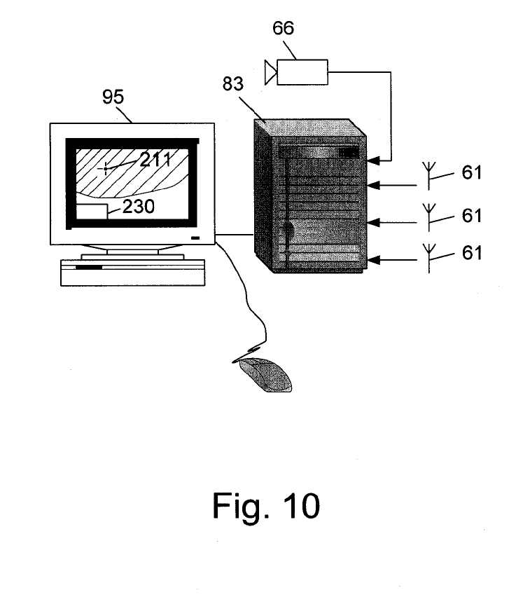

FIG. 10 illustrates the components of the base station which are: 3 antennas 61, a processing unit 83, a video camera and a display screen 95. In this particular drawing a drowning event 211 is displayed.

FIG. 10 shows a drowning event at a monitored bathing zone, as displayed in the lifeguard's station 70. For example, a partition of the frame 230 is dedicated for showing the drowning event by video camera 66. Alternatively, by similar software means the drowning event 211 could be presented in information layers.

According to another embodiment, the system proposed by the present invention may also be used for detecting).

A microphone that may be used according to the present invention is for example, the WM-61A (manufactured by Panasonic, Japan), followed by a microphone amplifier, for example, the P93 (manufactured by Elliott Sound Products), which is a discrete fully Class-A transformer-less design, which offers high performance at comparatively low cost. Traditionally, measurement microphones are calibrated, so that the exact output level for a given Source Power Level (SPL) is known, and so that the frequency response is predictable and accurate.

A measurement microphone is not calibrated for level or response, but relies on the reasonably predictable performance of electret (a stable dielectric material with a permanently embedded static electric charge) microphone units, which are readily available. Electret microphones are typically powered from a 1.5V battery.

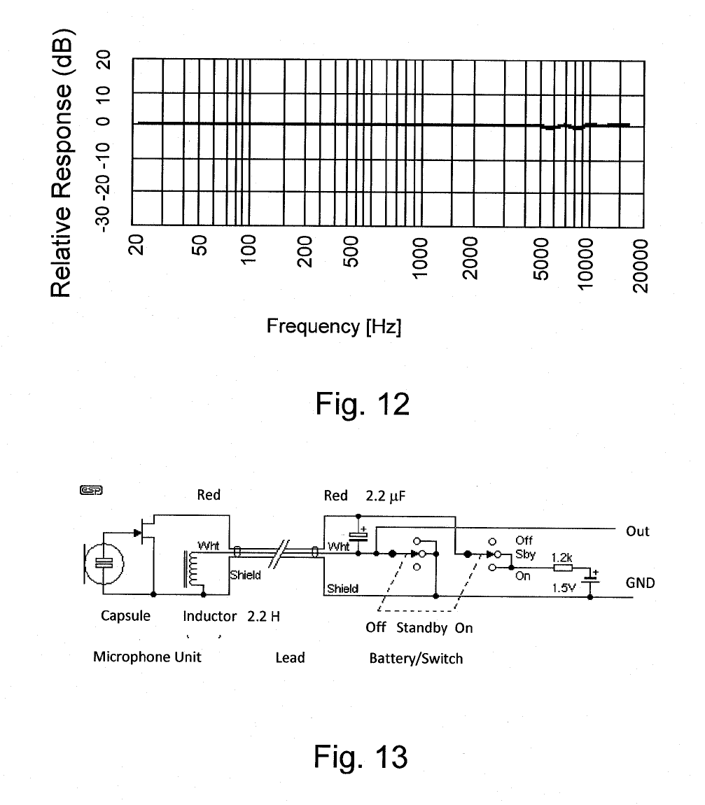

FIG. 12 shows a typical frequency response of a WM-61A Panasonic electret microphone.

FIG. 13 illustrates a typical electret microphone schematic diagram, where the inductor is not usually used. Since the output impedance of a typical electret microphone is relatively high (typically about 1 k to 5 k), an operational amplifier is added to buffer the output, making sure that the output impedance is kept low (about 100 ohms), so as to be able to drive any mixer.

The limited signal output level (with relatively low sensitivity) is increased by increasing the supply voltage up to 9 V. By doing so, the noise is reduced and the sound level handling capability is increased, since with a larger signal from the microphone the noise contribution,is lower, and a higher supply voltage allows a higher output voltage before distortions are introduced.

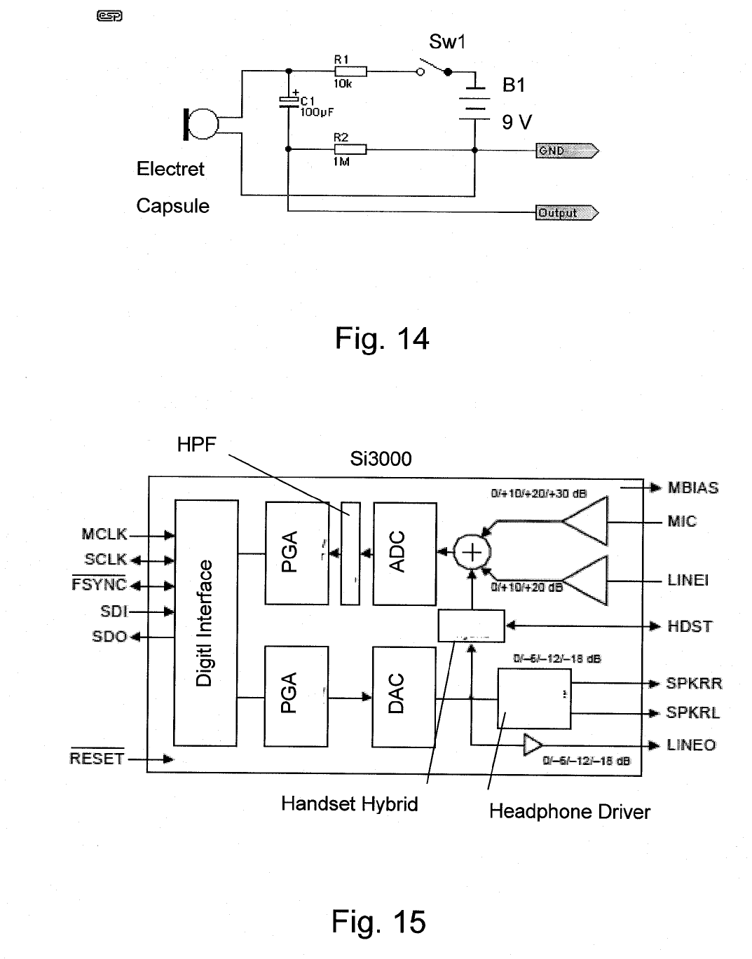

FIG. 14 shows a typical remote powered microphone schematic that can be used directly as a measurement microphone with a 9V battery with improved performance (as long as lead lengths are kept shorter than 1 meter). Generally, this circuit should only be used with cable with length of maximum 1 meter, so as to maintain low capacitance. It is also possible to add an operational amplifier to reduce the output impedance and to have some extra gain.

Sound Pressure Level (SPL)

Since normally electret microphones have an integral amplifier, they will always introduce a level of distortion. A typical capsulated microphone has a 10 kohms feed resistor and supplied from a 15V power supply that outputs above 1 V RMS when being close enough to the mouth. The sensitivity can be reduced by reducing the value of the feed resistor.

A possible implementation may be a chain of microphones with preamps, as required, as well as software for sampling and processing the received signals according to the processes described above. Alternatively, it is possible to implement an embedded device that includes a voiceband codec with microphone/speaker drive. For example, the Si3000 (Silicon Labs., TX, U.S.A.) is a complete voice band audio codec solution that offers high integration capability by incorporating programmable input and output gain/attenuation, a microphone bias circuit, a handset hybrid circuit, and an output drive for 32 OHM headphones. The SI evaluation kit (shown in FIG. 15) includes all necessary envelopment, libraries and function to be used in order to develop applications for voice recognition.

This codec performs analog to digital conversion of the voice for input to the DSP, as well as Digital to Analog conversion with programmable gain for the output to the codec speaker.

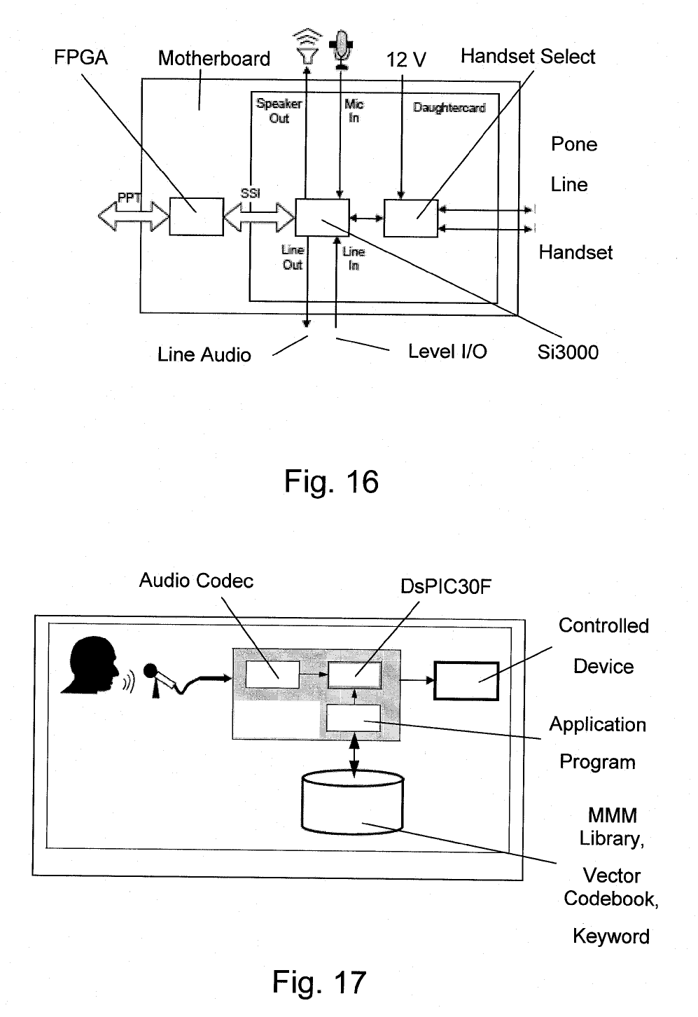

Another possible implementation using routing with FPGA is shown in FIG. 16.

Another possible solution is based on PIC processors with DSPIC30F Speech Recognition Library which provides an audio interface to a user's application program, for allowing the user to control the application by uttering discrete words that are contained in a predefined word library. The words chosen for the library are specifically relevant to the interaction between the application program and the user. Upon recognition of a word, the application program takes an appropriate action, as shown in FIG. 17.

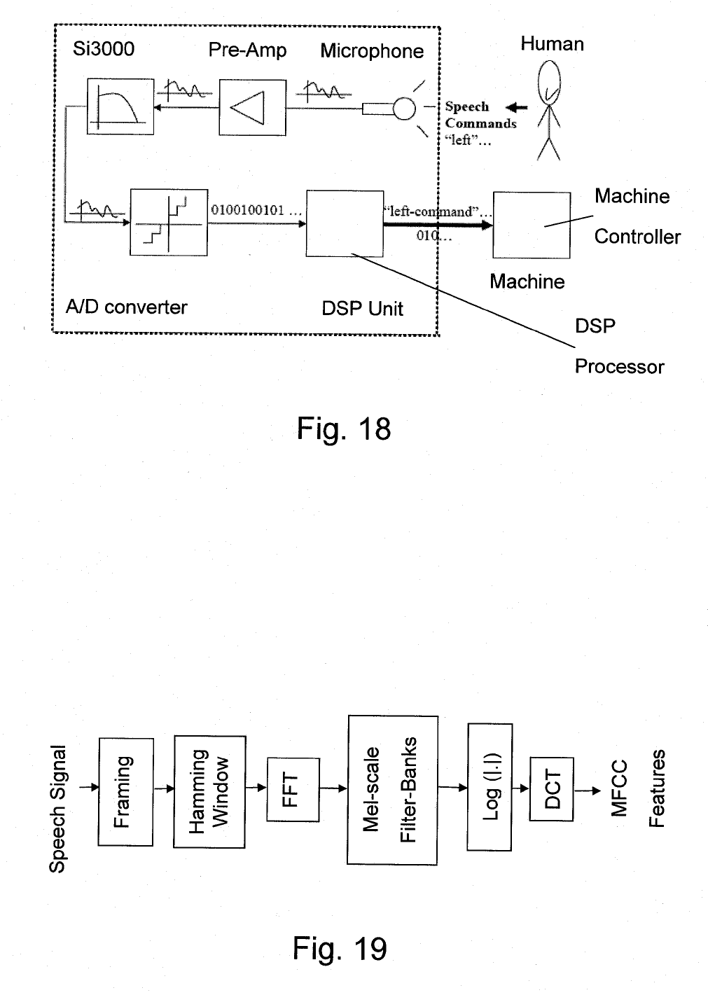

FIG. 18 shows another system implementation, where the DSP may be replaced by a micro controller or an FPGA.

### EXAMPLE

### Mel Coefficients

Speech recognition has better performance when the recognizer is fed with compact feature vectors. Mel-Frequency Cepstral Coefficients (MFCCs—Mel-frequency cepstrum (MFC) is a representation of the short-term power spectrum of a sound, based on a linear cosine transform of a log power spectrum on a nonlinear Mel Scale of frequency) are widely accepted and used to represent speech signals, preserving the speech characteristics, while reducing the effects of speech variability [Deller 2000]. Furthermore, Davis et al. concluded that MFCC features outperform other types of speech signal representation, especially when used for monosyllabic word recognition [Davis, 1980]. Moreover, Kurcan showed that MFCC features yielded better results than other parameters considered and were effective in the isolated word recognition case [Kurcan, 2006]. The same approach is implemented in this example using the hardware shown in FIG. 17.

Speech data are framed in 256-sample frames corresponding to 32 mSec, overlapped by 53%, to better capture temporal changes from frame to frame. Speech frames are windowed by applying a Hamming window w(n). In each frame, a complex 256-Fast Fourier Transform is applied to transform the signal from the time to the frequency domain. The frequency information obtained in each speech frame is passed through the Mel filter-bank, resulting in 24 frequency coefficients per frame. A logarithmic transformation is applied to the magnitude of each Mel frequency coefficients, discarding the phase information, dynamically compressing the features, and making feature extraction less sensitive to speaker-dependent variations [Becchetti, 1999].

The Mel-frequency Cepstral coefficients are finally computed by applying the inverse DFT to the logarithm of the magnitude of the filter-bank outputs. The inverse DFT reduces to a Discrete Cosine Transform (DCT) operation as the log magnitude spectra of the coefficients are real and symmetric [Becchetti, 1999], Moreover, the DCT has the advantage of producing highly uncorrelated features [Jayant, 1984; Deng 2003]. The resulting output is the Mel-frequency cepstral coefficients c(k). FIG. 19 shows a block diagram of MFCC Feature Extraction.

It is also possible to use Microelectromechanical systems (MEMS—a technology of very small mechanical devices driven by electricity) to detect and analyze voice signals. In this case, the sound waves will drive MEMS devices that will generate signals. These signals will be read and processed in order to identify cough patterns.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A life saving necklace worn around the neck of a person submersed in a liquid medium, comprising:
three or more microphones symmetrically distributed along a necklace circumference for transmitting sounds originated from the throat of a person submersed in a liquid medium;
a processor for processing signals received from each of said microphones representing a cough sound being typical of a drowning person, wherein said processor is operable to separate the signals received from a first of said microphones from the signals received from another of said microphones by Independent Component Analysis (ICA), to compare each of said separated signals with a baseline cough pattern, and to automatically transmit a distress signal to a base station when at least one of said separated signals is indicative of a distress condition;
a memory for storing data and operating software for said processor; and
an electric power source for providing power to electrical components of said necklace.

2. The life saving necklace according to claim 1, in which the processor processes signals received from the microphones according to the following steps:
a) assigning a filter to each channel, according to the relevant frequency band of the cough signal;
b) isolating the cough signals from environment noises using Blind Source Separation (BSS), according to the location of each source on the neck;
c) performing segmentation of the cough signals into constant or variable segments, according to the types of signals;
d) extracting the cough attributes from each segment, using a Short-Term Fourier Transform (STFT) or a Fast Wavelet Transform (FWT);
e) classifying said attributes by comparing the patterns of each segment or several segments to cough patterns of a bather and of other bathers that are stored in a database; and
f) making a decision whether or not the cough is related to a distress condition, according to the comparison results.

3. A drowning detection and alert system, comprising:
a) a life saving necklace worn around the neck of a person submersed in a liquid medium, including:
i. three or more microphones symmetrically distributed along a necklace circumference for transmitting sounds originated from the throat of a person submersed in a liquid medium;
ii. a processor for processing signals received from each of said microphones representing a cough sound being typical of a drowning person, wherein said processor is operable to separate the signals received from a first of said microphones from the signals received from another of said microphones by Independent Component Analysis (ICA), to compare each of said separated signals with a baseline cough pattern, and to automatically transmit a distress signal when at least one of said separated signals is indicative of a distress condition;
iii. a transceiver for communicating with a base station;
iv. a memory for storing data and operating software for said processor; and
v. an electric power source for providing power to electrical components of said necklace;
b) said base station including:
i. a receiver capable of receiving said distress signal; and
ii. computational means and display means operable to provide, when a drowning event is detected, an audio visual alarm including the location of said drowning person.

4. A drowning detection method, comprising the steps of:
a) obtaining predefined personal expected patterns of user characteristic voluntary cough and normal breathing sounds;
b) receiving input representing a cough or breathing sound being typical of a drowning person from three or more microphones symmetrically distributed along a circumference of a necklace worn around the neck of said drowning person;
c) separating the signals input from a first of said microphones from the signals received from another of said microphones by Independent Component Analysis (ICA);
d) identifying whether the cough or breathing sounds received from each of said separated signals are compatible with the predefined personal expected pattern;
e) generating a distress signal to be received by a base station when the received cough and breathing sounds are different from the predefined personal expected pattern; and
f) activating an audio visible alarm.

5. The drowning detection method of claim 4, further comprising the steps of:
a) filtering out irrelevant frequencies from each of the separated signals; and
b) identifying whether each of said filtered signals represents a cough sound by recognizing explosive sound patterns.

6. The drowning detection method of claim 4, further comprising the steps of:
a) producing an averaged signal from the received input signals;
b) filtering out irrelevant frequencies from said averaged signal; and
c) identifying whether said averaged signal represents a cough sound by recognizing explosive sounds.

7. The drowning detection method of claim 4, wherein an alarm is generated if one or more of the following conditions occur:
a) cough pattern changes being more frequent than 4 coughs within 15 seconds;
b) cough pattern with an increasing intensity;
c) cough pattern with characteristics different from the predefined personal expected voluntary pattern; and
d) wheezing.

8. The drowning detection method of claim 4, wherein an alarm is generated if one or more of the following conditions are met:
apnea longer than period of 7 to 20 seconds is detected 5 seconds after an alarm cough; and
apnea longer than period of 7 seconds is detected.

9. The drowning detection method of claim 4, wherein an alarm is generated if a loss of any background noise was present in the last 5 seconds.

10. The drowning detection method of claim 4, wherein an alarm is generated in case of a continuous change of frequencies for a time period of more than 15 seconds.

11. The life saving necklace according to claim 1, in which the microphone is an electret microphone units powered from a 9V battery.

12. The life saving necklace according to claim 1, in which an operational amplifier is added to the output of the microphone.

13. The life saving necklace according to claim 1, in which routing between microphones is done by an FPGA.

14. The life saving necklace according to claim 1, in which the sound signals are analyzed by calculating Mel-Frequency Cepstral Coefficients and applying a Discrete Cosine Transform (DCT) operation.

15. The life saving necklace according to claim 1, in which MEMS technology is used to detect sound.

16. The life saving necklace according to claim 1, in which 6 to 8 microphones are symmetrically distributed along the necklace circumference.

17. The drowning detection method of claim 4, further comprising the steps of:
a) filtering out irrelevant frequencies from each of the separated signals; and
b) identifying whether each of said filtered signals represents a cough sound by recognizing explosive sounds.
